(19) United States
(12) Patent Application Publication
(10) Pub. No.: US 2016/0213008 A1
(43) Pub. Date: Jul. 28, 2016

(54) ULTRASONIC MICRO-DROPLET RELEASE OF MATRIX BOUND FOOD DERIVED ANTIMICROBIALS

(71) Applicant: Siamak TABIBZADEH, Newport Coast, CA (US)

(72) Inventor: Siamak TABIBZADEH, Newport Coast, CA (US)

(21) Appl. No.: 15/006,920

(22) Filed: Jan. 26, 2016

Related U.S. Application Data
(60) Provisional application No. 62/108,522, filed on Jan. 27, 2015.

(51) Int. Cl. A01N 65/40; A23L 3/3454; A01N 37/44

(52) U.S. Cl. CPC A01N 65/40; A01N 37/44; A23L 3/3454

(57) ABSTRACT

Food consumed by humans may not have innate antimicrobial activity and for this reason, it requires preservatives to prevent microbial spoilage and to extend food shelf life. Disclosed herein is a method for capture, and slow, and sustained release of food derived preservative and anti-microbials from a matrix with ultrasonically derived micro-droplets. The growth of microbes on food and other perishable or non-perishable items is prevented and food freshness is extended by keeping them within an environment where preservative is slowly released.

### CLAIM OF PRIORITY

This application claims priority to U.S. Provisional Application No. 62/108,522, filed Jan. 27, 2015, which is incorporated by reference in its entirety.

### FIELD OF THE INVENTION

This invention relates to food preservation.

### BACKGROUND

Both quantitative and qualitative food losses occur from harvesting, handling, storage, processing and marketing, to the final delivery of the products to the consumer. The latest published values indicate that, each year, industrialized and developing countries dispose of roughly similar quantities of food. In the developed countries, the losses occur at the levels of retailers and consumers. However, in the under-developed countries, because of poor infrastructure, low levels of technology, and low investment in food production systems, the losses occur at multiple levels including during the production, harvest, post-harvest and processing phases. The post-harvest losses of fruits and vegetables in the developing countries account for almost 50% of the produce.

As estimated by the Perishables Group, Inc., in the years 2005-2006, the average rate of loss for fresh fruit, vegetable, meat, and poultry commodities at the supermarket level, varied from 0.6 percent for sweet corn to 63.6 percent for mustard greens. The study showed that the impact on per capita varied broadly among diverse commodities. Annual supermarket losses in 2006 were 8.4 to 51 percent for fresh fruit with an averaged of 11.4 percent, 9.7 percent for fresh vegetables, and 4.5 percent for fresh meat, poultry, and seafood.

Food and Agricultural Organization (FAO) of the United Nations estimates that 25 to 35 percent of the world food production is lost through natural causes such as pests, microbes, and insects. In the ASEAN countries alone, post-harvest losses are estimated to be 30 percent for cereals, 20 to 40 percent for fruits and vegetables, and up to 50 percent for fish. Some products in Africa show post-harvest losses as high as 50 percent. Rather than increasing production, one of the best actions to the problem of the world hunger, is to preserve what has already been grown . If worldwide post-harvest losses can be minimized, food supply gains removes the necessity to allocate additional resources to further expansion of food cultivation.

Spoilage of food is a process of deterioration that reduces the edibility of food. Ultimately, foods that are partially or completely spoiled become un-edible. Foods that are capable of such spoilage are referred to as being “perishable.” Degradation, loss of color and dissipation of flavor of freshly cut plants is due to a variety of reasons including metal ions, oxidation, enzymatic effects, and growth of microorganisms on food. Autolysis, the process that, over time, is largely responsible for the change in color, texture, and flavor of food, occurs because of effects of enzymes that are naturally present in all plants and animals. The impact of atmospheric oxygen induces changes in color of food and can increase the level of rancidity of food. Finally, infestations (invasions) by insects and rodents account for huge losses in food stocks.

Softening, and discoloration are common changes that occur during ripening and then during the senescence of fruits. Generally, reduction in fruit firmness due to softening is accompanied by an increased expression of cell wall-degrading enzymes. The ripening and senescence of post-harvest fruits is a complex and highly regulated process that involves lipid peroxidation, resulting in the loss of integrity of the plasma membrane. The softening that accompanies ripening enhances fruit damage during shipping and handling processes. This softening plays a major role in determining the cost of fruits because it directly impacts shelf life, resistance to post-harvest diseases and pathogens and on the palatability and consumer acceptability.

Endogenous signaling molecules and hormones such as ethylene, ABA, auxin, IP3, Ca²⁺, H₂O₂, and NO are involved in food ripening. An in-evitable result of mitochondrial, chloroplast and plasma membrane-linked electron transport is production of reactive oxygen species (ROS) including H₂O₂. The reactive nature of ROS, therefore, makes them harmful to all cellular components and cause damage by oxidizing various macromolecules in both plant and mammalian cells. This overproduction of ROS and oxidative damage is a universal event which contributes to the spoilage of post-harvest fruits during storage. Thus, it follows that inhibition of these oxidative damages would prolong the shelf life of post-harvest fruits.

Besides the chemical reactions that spoil food, one of the primary causes of food spoilage is growth of micro-organisms including bacteria and yeast (mold) on food products. The toxic effect from the consumption of spoiled food causes “food poisoning” or “food borne illness.” Some bacteria such as E. coli or Salmonella that grow on food directly threaten the human health. Foods with a high sugar content are susceptible to growth of yeast. Micro-organisms including bacteria and yeast break down food and produce by-products such as acids that lead to changes in taste, texture, aroma, and color that make food less edible. Spoiled, un-cooked, or under-cooked animal meat is typically quite toxic, and its consumption can result in serious illness or death.

Food decay is a process that includes putrefaction, fermentation and rancidity. Putrefaction is one of the seven stages in the decomposition of the body of a dead animal. Fermentation is a metabolic process whereby electrons are ultimately transferred to breakdown molecules of the same nutrients. Rancidification, on the other hand, results from chemical decomposition of fats, oils and other lipids. There are three types of rancidity: ester hydrolytic, oxidative and microbial. Hydrolytic rancidity occurs when fatty acid chains split away by water from the glycerol backbone in triglycerides (fats). Because most fatty acids are odorless and tasteless, this process usually goes un-noticed. However, when rancidification progresses to the release of carboxylic acid from the triglycerides, strong flavors and odors are acquired. In the case of old butter, such flavors and odors are acquired when rancidification leads to a high content of derivatives of butyric acid. Oxidative rancidity is associated primarily with the degradation of un-saturated fat by oxygen. During this process, the double bonds of an un-saturated fatty acid undergo cleavage, releasing volatile aldehydes and ketones. This process can be suppressed by the exclusion of oxygen or by the addition of antioxidants. Microbial rancidity refers to a process by which lipases in the micro-organisms break down the fat in the food. This process can be prevented by sterilization when the food is not perishable by heat. Generally, food decay, as a result of these processes, leads to un-desirable odors and flavors. In processed meats, these flavors are collectively known as warmed over-flavors. Rancidification reduces the nutritional value of the food. Some vitamins are highly sensitive to such degradation processes.

Since the dawn of civilization, mankind has been concerned with the preservation of food. During early civilization, food preservation processes developed slowly and were mainly limited to smoking or curing with salt. With the advent of the industrial revolution and the discovery that food spoilage was due to the activity of living organisms such as bacteria, yeast or molds, the art of preserving food developed rapidly. Due to the health hazards that spoiled food poses, there is a great interest in preserving food and preventing its spoilage. A number of methods have been devised that prevent or slow down this process, expand the shelf-life of food and prolong the duration that food can be consumed. Acidulants are known to prevent microbial degradation by maintaining a relatively low pH environment, but their effectiveness is limited just to temporary conservation.

Present day methodologies for preserving food include sterilization by heat, refrigeration, pickling and the addition of chemical preservatives, Ohmic and dielectric heating, which includes radio frequency (RF) and microwave (MW) heating as well as non-thermal processing. Among other methods are freezing, vacuum sealing (removes oxygen required for growth of micro-organisms), or drying which, by removing water, prevents the growth of micro-organisms. All these techniques prolong food shelf-life.

Among the preservation technologies, chemicals used for food preservation can seep into foods and such substances can not be sufficiently removed for safe consumption by humans. Also, many of the currently used methods are not suitable for all types of perishable foods such as fruits and vegetables. Perishable substances, as described in the present application, also include non-edible perishable substances. Thus, what is needed in preserving food and prevention of growth of micro-organisms is using a method that is safe, cost effective and easy to carry out, particularly for the class of food such as fruits and vegetables, for which, there is no preservation technology available to maintain food freshness.

Many natural compounds can lock food freshness and have antimicrobial properties, however, very few have ever been used to enhance food shelf-life. The new restrictions by the food industry and regulatory agencies in the use of some synthetic food additives, have led to a renewed interest in organic natural compounds and more specifically those that are derived from plants. The current trend of interest in organic food also requires that organic food not to be preserved with chemicals rather with preservatives from natural sources such as those derived from herbs, spices, seasonings or botanical extracts since these foods have been used for centuries by humans without ill effects.

The existing problems in preservation of certain foods that spoil, therefore, require a continuing search for effective, and technically and economically feasible method of food preservation. In addition, the preservation technology must be organic, cheap, safe, should have a good life-span, not subject to rapid degradation, should have broad range of anti-bacterial and anti-fungal activities since different microorganisms grow on different food, should not change the aroma and flavor of food, and must be active from 4 to 25° C.

### SUMMARY

Thus, as a further advance to this field, a system and process of food perseveration and for prevention of microbial growth is described. The system and process can involve one or more of the following: 1. creating a food preservative from food, or components in food; the term food is used to include all edible substances. 2. combining such components in a manner to lock food freshness, to prevent growth of a broad range of micro-organisms and to increase food shelf-life; 3. devising a method for their capture on a matrix; and 4. delivering the components released from matrix via ultrasonically created micro-droplets. The method that is provided increases food shelf-life and prevents growth of microorganisms on food exposed to volatile substances captured from preservative and subsequently emitted from the micro-droplets.

Other features and associated advantages of the present invention will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein. In the depicted figures, the number of colonies on Agar plates were counted daily and shown on day 2. The figures shown are a representation of 6-12 set of such cultures. p Values are shown as <0.05 (*), <0.005 (**) or <0.0005.

FIG. 1 depicts configuration of a food preservation chamber. The figure depicts A: the configuration of a typical and workable food preservation chamber with its dimensions and the flow rate of micro-droplets and B: the structure, the thickness of each layer and dimensions of the cartridge.

FIG. 2 depicts the effect of Zeolite loaded with substances in garlic extract on microbial growth. Garlic was crushed and the juices were extracted with a commercial juicer, the juice was loaded onto the Zeolite and then dried (see text for details). The Zeolite was used without (0) and with 1 or 4 grams of Zeolite pre-loaded with garlic extract. Agar plates streaked with serial dilutions of fungus isolated from spoiled strawberry were then placed within the preservation chamber and the chamber was closed. Flow rate from ultrasonic device (Crane; Model EE-5301) into the chamber was adjusted to 1 and 10 ml/hr/cubic feet.

FIG. 3 depicts the effect of Zeolite loaded with substances in garlic extract on microbial growth without and with cysteine. Several cartridges were created, a cartridge loaded with layers of 1 gram Zeolite mixed 100 μg cysteine (C), a cartridge with 1 gram Zeolite loaded with substances in garlic extract (G), and a cartridge with 1 gram of Zeolite mixed with 100 μg cysteine and with 1 gram Zeolite loaded with substances in garlic extract (G+C). Agar plates streaked with serial dilutions of fungus isolated from spoiled strawberry were placed within a chamber and the chamber was closed. Flow rate from ultrasonic device into the chamber was adjusted to 1 and 10 ml/hr/cubic feet.

FIG. 4 depicts the effect of Zeolite loaded with substances emitted from a variety of herbs and spices. Two sets of cartridges were made. One with Zeolite alone (A) and one loaded with Zeolite loaded with proprietary series of substances in a variety of herbs and spices (B). Agar plates were streaked with serial dilutions of fungus isolated from spoiled strawberry and then the cultures were placed within a chamber and the chamber was closed. Flow rate from ultrasonic device into the chamber was adjusted to 1 and 10 ml/hr/cubic feet.

FIG. 5 depicts the effect of Zeolite loaded with substances in a variety of herbs and spices. Two sets of cartridges were made. One with matrix alone and one loaded with substances in a variety of herbs and spices. Raspberry, strawberry and bread were placed within each chamber that received the micro-droplets at room temperature for 25 hours. Then, the fruits were exposed to air for 7 additional days in the absence of micro-droplets. Mold (arrows) is grossly visible in the control non-preserved fruits and bread (A) and not in those preserved (B).

### DETAILED DESCRIPTION

Specific requirements as necessary for various features, aspects, and advantages of the present invention will become more apparent from the following detailed description of preferred embodiments of the invention, along with the accompanying drawings in which like numerals represent like components. To this end, food derived components of food with differing anti-microbial properties were captured on a matrix and then allowed their slow release to increase food shelf-life and freshness. Acquiring, retaining and slowly releasing food derived substances with special properties from a matrix by ultrasonically generated micro-droplets requires: 1. a matrix that binds compounds with the desired activity such as antimicrobial property, 2. active compounds with such an activity, 3. binding of the compounds with said property to the matrix with and without the use of solvents and/or carriers, and/or heat, 4. creation of a cartridge that supports the activation and elaboration of active compounds from the said matrix, and 5. delivery of active compounds to a close chamber by a flow of micro-droplets generated by an ultrasonic device.

### 1. Matrix.

Many porous and absorbent substrates that exist naturally and their use in food industry is considered safe for human consumption. Among these, diatomaceous earth is a siliceous sedimentary soft rock that easily crumbles into a fine powder comprised of 80 to 90% silica, 2 to 4% alumina and 0.5 to 2% iron oxide. The microscopic matrix of diatomaceous earth makes it a highly effective absorbent for other compounds including gases. Other substances with similar properties exist and include natural or synthetic Zeolites, Celite, Perlite, Silica Gel, Aluminas, Magnesium Aluminate, Aluminosilicates, Magnesium Silicates, Active Carbon, Clays Such As Bentonite, Sepiolite, Attapulgite, Vermiculite, or Mica, and mixtures thereof.

Zeolites are abundant hydrated alkali metal or alkaline earth metal salts of crystalline alumino-silicates with a three-dimensional pore structure that makes them natural adsorbents and desorbents. Clinoptilolites are one the most abundant Zeolites and are used in various applications. The absorbing capability of Zeolites varies and it depends on composition of the Zeolite, the diameter of the particles and the temperature. Chemical composition of Zeolite varies and might include SiO₂, Al₂O₃, Fe₂O, CaO, MgO, Na₂O, or K₂O. For example, a calcined clinoptilolite with an average diameter particle size of 250 μm when subjected to a gas mixture of 1.06% H₂S in helium at temperatures of 600° C. can absorb about 0.03 S/g of this gas (Yasyerli et al, Chemical Engineering and Processing 41, 2002, 785-792). Zeolites are shown to capture liquids such as water (H₂O), and gases such as N₂, O₂, CO₂ , H₂S or SO₂. Other separations include noble gases, N₂, 0₂, Freon or formaldehyde. Thus, Zeolites broadly retain both liquids and gases.

### Matrix Particle Size.

To this end, volatile and non-volatile substances in food were methodically tested to decipher their capture on a matrix. The matrix is desirably Zeolite and is used by granulating it into appropriate sizes by a variety of techniques such as an extrusion granulating method, a rotary granulating method, a compression granulating method, or other conventional granulating methods, known to artisans. Depending on the applications, the particle size of Zeolite is not limited and can vary from about several millimeters to 300 mesh or less (50-10 mesh). For improving the mechanical strength and flowability (or fluidity) of the Zeolite particles or to decrease the production cost, other substances such as Bentonite, clay, talc, kaolin, calcium carbonate, diatomaceous earth, and similar substances can be optionally used as a binder, lubricant, or bulk filler. Color or aroma of the product might also be changed by use of natural coloring and aromatic compounds. The present inventor has found that natural or synthetic Zeolite particles can adsorb and retain a relatively large amount of natural food substances including those that are volatile that exist in a variety of food contents with good adsorbability and stability and can efficiently release the adsorbed activity upon addition of an activator including but not limited to cysteine, water or oil. The formulation is suitable for preservation of perishable foods such as fruits and vegetables and for prevention of microbial growth on food or non-food items. The formulation is also suitable for prevention of microbial growth on non-edible perishable or non-perishable substances, surfaces and objects without the requirement of heat.

### Matrix Dehydration.

Because active compounds that bind Zeolite degrade in presence of water, before use, matrix, desirably Zeolite, depending on the level of wetness is dehydrated by subjecting it, to a minimum of 6 hours of a thermal treatment at a temperature of 200° C. to 700° C., desirably 500° C.

### 2. Active (Volatile, Non-Volatile) Substances.

Here, active substance(s) in food is defined as those with specific desired property including antimicrobial activity. Active compounds from food and food derived components are those that show a range of specific activities including those that lock food freshness, firmness, aroma, color and taste and prevent growth of microorganisms on food. Foods, spices and herbs have active compounds with such properties. However, foods, spices and herbs are not used as a food preservative for several reasons. These may not be potent in their natural state, may have a limited range of antimicrobial activity, and may show a great variability among plants. Thus, in one respect, food derived formulations with active substances derived from food are devised that show consistent long term antimicrobial property and prolong food shelf-life and freshness.

### Use of Heat or a Solvent.

If active substance(s) is not present in liquid form at ambient temperature and which is not soluble in water, it will be heated or dissolved in a suitable solvent. The temperature can be raised to include the active substances that have a higher melting point. Alternatively, solvents can be used for solubilizing the active substance and the use of solvents for dissolving active compounds in the production of the present food preservative composition are not specifically limited for so long as the active compound does not react with or decompose in the solvent. Desirable solvents are aprotic solvents which are compatible with the active compound(s). Typical examples of such solvents are aromatic hydrocarbons such as benzene, toluene, or xylene; linear or cyclic aliphatic hydrocarbons such as pentane, hexane, heptane, octane, or cyclohexane; halogenated hydrocarbons such as dibromoethane dichloropropane, dichloropropene, chlorobenzene, or dichlorobenzene; or cyclic aliphatic ether such as tetrahydrofuran or dioxane. Once the Zeolite is contacted with active ingredient, it is allowed to dry.

### Use of an Activator.

In some instances, when activation of preservative compounds on a matrix requires and activator, such a compound is included in a layer of matrix.

### Use of a Hygroscopic Matrix.

If preservative compounds loaded onto matrix are activated by water, a hygroscopic layer of a matrix is layered over the layers with active compounds to allow for slow activation of preservative compounds.

### 3. Loading of Active Substance Onto the Matrix.

Active substance(s) is supported on the Zeolite, generally in an amount of 1 part Zeolite and 0.05 to 0.5 parts by weight, desirably 0.08 to 0.2 parts by weight of the active compound(s). Active substance is supported on the zeolite particles by any conventional method such as a dipping method. Generally, active compounds are loaded onto the zeolite by contacting Zeolite with a liquid to allow for their adsorption of active compounds that have a melting point at room temperature onto Zeolite.

4. Assembly of a Cartridge with Food Preserving Property.

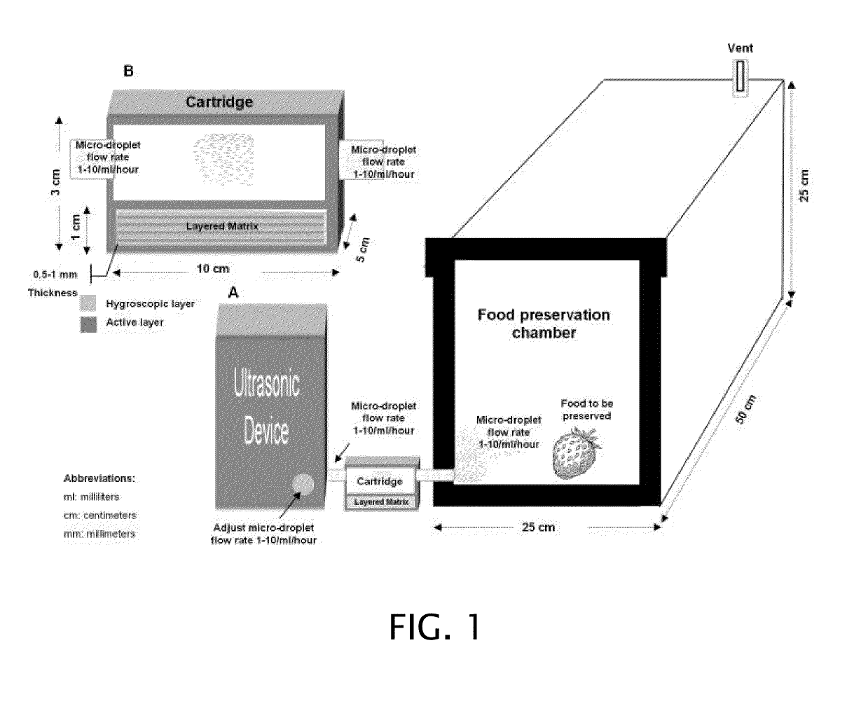

A cartridge was devised that includes a free space overlying a layered matrix (FIG. 1). Matrix can be configured in several different ways comprised of any substrate that binds molecules with food preserving and antimicrobial property and allows their activation and gradual constant release. Layers with dried Zeolite pre-loaded with active preservative compound(s) were placed as a powder within the cartridge forming layers with thickness varying from 0.5-1 mm desirably 0.5 mm in thickness. These layers might be over-layered with a hygroscopic matrix that absorbs a solvent desirably water that allows release of active preservative compounds with food preserving property from the matrix. In configurations that active preservative compounds are released in a sustained manner from matrix, the addition of the hygroscopic matrix layers is not required. The flow of water micro-droplets allows the release of active preservative compounds from matrix and these are captured by micro-droplets that exist in the cartridge. The micro-droplets are routed to a chamber where food is kept at temperatures of 4-25° C. desirably at 4° C. 7. Delivery of the food preservatives with micro-droplet ultrasonic technology into the food preservation chamber.

It is also another aspect that formulation with active substances to be retained and slowly released in a sustained manner the desired activity. In accordance with such requirements, there is provided formulations comprising active substances in food with known activity to be released from a matrix by an ultrasonically derived micro-droplet technology. Chester J. Cavallito and colleagues in 1944 discovered that crushed garlic (Allium sativum) exhibits antibacterial and antifungal activity. This activity is attributable to allicin, an organosulfur compound of garlic of the species Alliaceae. Crushing converts alliin to allicin which is unstable and generates other organosulfur compounds such as ajoene, vindyldithiins, S-allylcysteine, and diallyl polydisulfides. Ajoene is an unsaturated disulfide which is formed from reaction of two allicin molecules and which also shows antimicrobial properties.

### 5. Ultrasonic Device Forming Micro-Droplets

The ultrasonic device generating micro-droplets that can be set, by a variable control, with the capacity to release from 4 Liters of water, 13 Liters of moisture per day suitable to cover at least 0.7-7 liters of space can be used dependent on the weight (more accurately surface area) of the food content within the chamber (4 Liter Water/13 Liters of moisture/500-5000 grams of food/0.7-7 liters of space). However, it becomes clear that other than delivery of the volatile substances by micro-droplets, such substances can also be delivered by a constant slow flow of air or other gas alone from the cartridge.

### 6. Food Preserving System

A food preservation system comprised of an ultrasonic device, attached to the food preserving cartridge which is connected to a food preservation chamber was devised (FIG. 1). Micro-droplets emitted from an ultrasonic device are routed through a tube to a cartridge. The tube exiting the cartridge must enter a chamber/container via an opening. The chamber where food is kept can vary in terms of size and volume. There is nothing specific about the food preservation chamber, other than it should be an enclosure that can be closed, and allows the entry and exit of the micro-droplets. Any container with a solid wall of any size and a perforations in the wall allowing the tube from the cartridge to be attached to the wall of the chamber can be used. The flow rate of micro-droplets that enter a container is proportional to the size of the chamber/container and the food content. Food can be placed anywhere within the chamber, preferentially placed at the bottom of the chamber or placed on multiple racks as long as the micro-droplets can travel between such racks.

### Sample Experiments

As used herein, the “effective amount” of constituent, compound, composition, preservative, or the like means an amount that exhibits effective antimicrobial activity, preferably wherein the antimicrobial activity is inhibiting growth of, eliminating, and/or otherwise decreasing the presence of microbials such as, for example, yeast, bacteria, mold, and fungus. Also, as used herein, the term “volatile” means that the food product is capable of releasing the active compounds at ambient temperature or by steam distillation at ambient pressure.

In a typical experiment and those represented below, using this system, the ultrasonically driven micro-droplet delivery of preservative substances were set up to assess the antimicrobial effect of our food preserving cartridges on bacterial and fungal cultures. Several different cartridges were developed and tested. Agar plates were streaked with serial dilutions of bacteria and fungi that grow on strawberry, raspberry, tomatoes, pineapple, and bread. These cultures were kept at room temperature within closed chambers that received micro-droplets and the number of colonies on plates were counted daily.

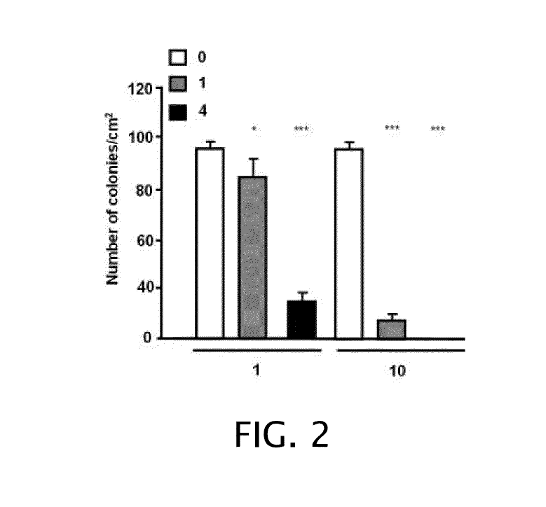

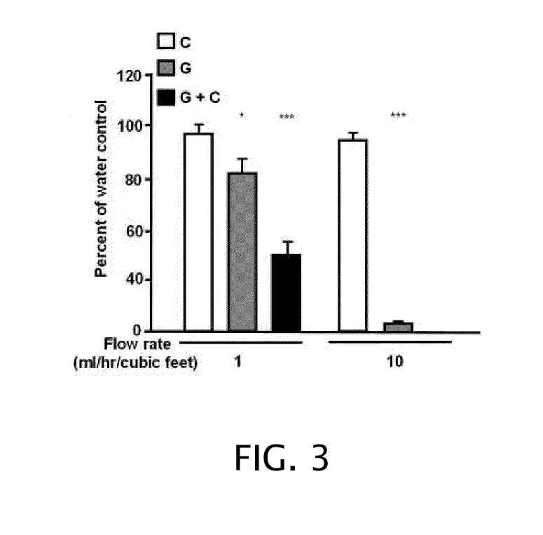

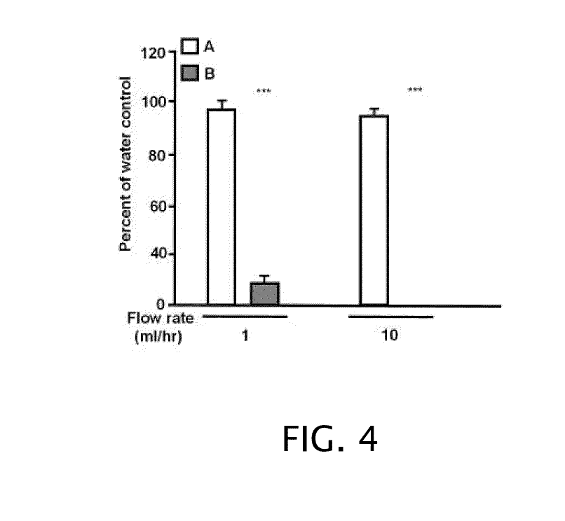

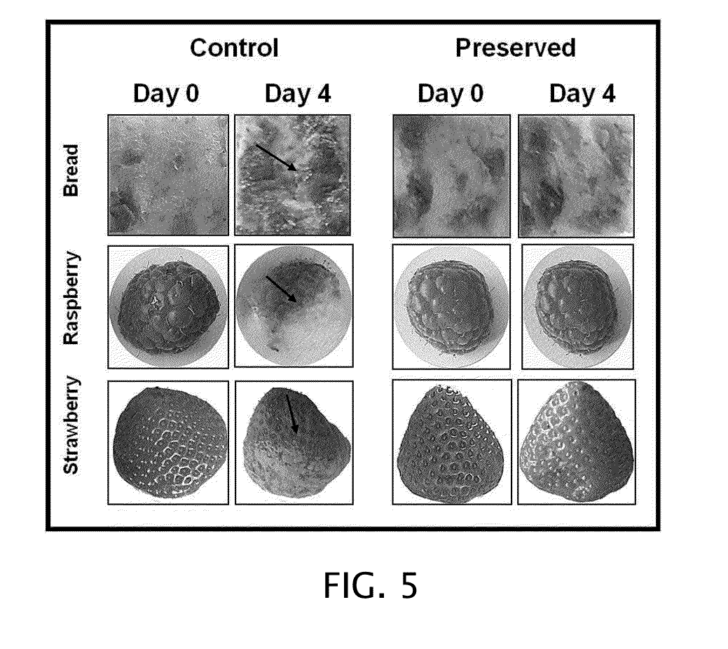

First, liquids were collected by cooling of the micro-droplets before and after passage through a cartridge stacked with layers of matrix with compounds of garlic without and with cysteine. Measurement of H₂S level was performed using Free Radical Analyzer (TBR4100 and ISO-H₂S-2, World Precision Instruments, Sarasota, FL) followed by the manufacturers' instruction. H₂S was detectable only in the liquid that were passed through a cartridge with garlic compounds and cysteine. Cartridges with compounds from garlic extract showed antimicrobial property (FIG. 2) and this effect was significantly increased when the matrix was mixed with cysteine that after absorption of water by matrix allows cysteine to mix with organosulfur in garlic to emit H₂S (FIG. 3). This activity was in proportion to the flow rate of micro-droplets (FIG. 2-3). The organosulfurs of garlic have strong smell and might change food aroma and/or taste. Various compounds from diverse spices were tried to develop a cartridge that exerts food preserving and antimicrobial property but does not influence food aroma, color or taste. Besides garlic, foods that showed anti-microbial property or accentuated the activity of other food included Broccoli, Chinese Broccoli, Broccoli Raab, Brussels Sprouts, Cabbages, Cauliflower, Bok Choy, Kale, Collards, Radishes, Onion, Poultry, Liver, Meat, Fish, Whole Egg, Egg white, Egg yolk, Milk, Cheese, Horseradish, Red Pepper, Black pepper, Wasabe, Soybean, Tofu (kori-dofu), Peanut, Walnut, Hoshi-shiitake, Mustard Seed, Orange, Ripe Yellow Fruits, Leafy Vegetables, Carrots, Pumpkin, Squash, Spinach, Soy Milk, Green Beans, Black Beans, Asparagus, various Mushrooms, Broccoli, Avocados, Nut Seed, Watercress and diverse processed food products including but not limited to Sriracha Hot Chilli Sauce (Huy Fong Foods, Inc), Gabriela Mustard (Western Gourmet), Ground Fresh Chilli Paste (Sambel Oelfk), and Spicy Brown Mustard (Trader's Joe). This is only a partial list and many more herbs, seasonings and food products exist that emit antimicrobial property and can be used in creating a preservative with a broad range of antimicrobial activity. A proprietary formulation was created that afforded such a food preservation property. Within the cartridge, the micro-droplets allowed release of active preservative by wetting the matrix and captured and delivered these into a chamber where food freshness was prolonged and growth of micro-organisms was inhibited (FIG. 4-5).

In summary, most preservatives are chemical and they may remain in the food and are consumed by the consumers. In order to overcome such inherent problems in current food preservation, formulations were developed from food that were captured and were then slowly released a desired activity without or with addition of an activator and described the practical method for its use in prolonging food shelf life by preserving food and inhibiting food spoilage.

Advantages of the developed formulation and method of use.

The method offers continuous protection of food, prevents food spoilage or decay, prolongs food shelf life, and prevents growth of micro-organisms. The method combines a series of advantages:
shows efficacy in increasing food shelf-life,
delays food ripening;
shows a broad range of anti-bacterial and anti-fungal activities;
provides a safe, natural preservation method for all perishable substances;
is food derived or are made of compounds considered safe for human consumption,
can be used at different temperatures with a minimum range of activity to be from 4 to 25° C.;
can be easily prepared for a variety of foods;
can be prepared in different formats including activation on demand;
that such a formulation utilizes relatively low cost starting materials;
has a good shelf-life, desirably for one year;
would not change color, flavor, aroma and texture of food;
that can be deployed for large-scale production;
lifts the requirement of the chemical preservative to come into contact with food;
can be applied to fruits, produce, plants, meat, poultry, fish, water or any other food product;
the method is non-thermal; and
can be used from the post-harvest time, during transport, and processing to distribution and sale of the food.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the perceived concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

Thus, specific embodiments of the process of food preservation have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. The food preservation cartridge comprising a housing including a layered matrix comprising a formulation including an absorptive material, a micro-droplet inlet entering the housing, and a micro-droplet outlet, wherein micro-droplets flow from the inlet, through the housing and over the absorptive material, and exit the outlet.

2. The cartridge of claim 1 wherein said formulation includes an active material derived from an edible substance.

3. The cartridge of claim 1 wherein said formulation includes an active material derived from a dried edible substance.

4. The cartridge of claim 1 wherein said formulation includes an active material is derived from an edible substance by drying, an aqueous or non-aqueous solution extraction, organic or non-organic solvent extraction, pH variation based extraction, chromatography separation, crude extraction, refined extraction, or combinations thereof of foods.

5. The cartridge of claim 1 wherein said food acquires but does not exhibit (dormant) a desired property after addition of a select group of “Activator Compounds” including but not limited to cysteine, water or oil.

6. The cartridge of claim 1 wherein said food acquires but does not exhibit (dormant) enhanced desired property after it is evaporated with a slow release mechanism.

7. The cartridge of claim 1 wherein food is formulated to exhibit a desired property such as but not limited to food preserving, antibacterial, antifungal, antiviral, insecticidal and insect repellent or other desirable property.

8. The cartridge of claim 1 wherein said formulation exhibits an activity selected from the group consisting of extending freshness, extending shelf life, preventing insect infestation, ameliorating insect infestation, preventing bacterial infection, ameliorating bacterial infection, preventing fungal infestation, ameliorating fungal infestation, preventing viral infection, ameliorating viral infection and combinations thereof, on said edible or non-edible, and perishable or non-perishable substance. The process for providing formulation in an environment using the cartridge of claim 1 to decontaminate or to prevent growth of living organisms and to act as a biocide or pesticide to kill microorganisms of interest including acting as fungicide to prevent the growth of molds and mildew, a disinfectant to prevent the growth and spread of bacteria, an insecticide to control a wide variety of bugs and insects and as a pediculicide or rodenticide to control mice and rats.

10. The process for providing formulation in an environment using the cartridge of claim 1 to protect an edible substance consisting but not limited to fruits, vegetables, grains or their products, meat or its products, fish, poultry, eggs, dairy products and combinations thereof.

11. The process for providing formulation in an environment using the cartridge of claim 1 to protect a non-edible substance consisting but not limited to paper, cardboard, paper products, paper derivatives, liquid, plastic, metal, glass, simple to complex chemicals or combinations thereof.

12. A method for preserving a perishable substance using release of anti-microbial compounds that are derived from edible substances.

13. A method for preserving a perishable substance using release of anti-microbial compounds that are derived from non-edible substances.

14. A method for preserving a perishable substance by slowing down the release of compounds with anti-microbial property by a chemical reaction with an absorbent that releases the compounds slowly.

15. A method for preserving a perishable substance by slowing down the release of compounds with anti-microbial property by slow evaporation of the compound in solid or non-solid form.
